(19) United States
(12) Patent Application Publication
(10) Pub. No.: US 2025/0229817 A1
(43) Pub. Date: Jul. 17, 2025

(54) WAGON ASSEMBLY WITH ROTATING HANDLE

(71) Applicant: Evenflo Company, Inc., Miamisburg, OH (US)

(72) Inventors: Gaylen W. ERCANBRACK, Plymouth, MA (US); Michelle M.J. WOOD, Rehoboth, MA (US); Charles H. KEEGAN, Milton, MA (US)

(21) Appl. No.: 18/411,550

(22) Filed: Jan. 12, 2024

(30) Foreign Application Priority Data
Sep. 11, 2023 (CN) 202322452236.6

(51) Int. Cl. B62B 3/00; B62B 3/02; B62B 5/06; B62B 5/08

(52) U.S. Cl. CPC B62B 3/007; B62B 3/02; B62B 5/065; B62B 5/067; B62B 5/082

(57) ABSTRACT

Embodiments of the present disclosure are directed to a wagon for transporting a baby or small child in the wagon, including a handle that can be rotated to various positions. For example, the handle of the wagon can be used in a push position, where the handle is fixed and extends behind the wagon and upwards towards a user. The handle can be rotated relative to a wagon frame, in some cases up to or exceeding approximately 180 degrees, so that the handle can move between pull and storage positions. In the pull position, the handle can be non-fixed and allow for some rotation during pulling of the wagon. A linkage, which may include a curvature, can be used on each side of the wagon to selectively lock the handle in place relative to the frame for a particular mode, such as a push mode or storage mode.

### CROSS-REFERENCE TO RELATED APPLICATION

This application claims the benefit of priority to Chinese Patent Application No. 202322452236.6, filed on Sep. 11, 2023, which is incorporated herein by reference in its entirety.

### SUMMARY

A high-level overview of various aspects of the invention are provided here, to provide an overview of the disclosure and to introduce a selection of concepts that are further described in the detailed-description section below. This summary is not intended to identify key features or essential features of the claimed subject matter, nor is it intended to be used as an aid in isolation to determine the scope of the claimed subject matter. The present disclosure is directed, in part, to embodiments of wagon assemblies.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE SEVERAL VIEWS OF THE DRAWINGS

Implementations of the present disclosure are described in detail below with reference to the attached drawing figures, wherein:

FIG. 1A illustrates a front perspective view of an exemplary embodiment of a wagon in accordance with aspects herein;

FIG. 1B illustrates a front perspective view of the wagon of FIG. 1A without softgoods in accordance with aspects herein;

FIG. 2 depicts a rear perspective view of the wagon of FIG. 1B wagon in accordance with aspects herein;

FIG. 3 depicts a side view of the wagon of FIG. 1B in a push position in accordance with aspects herein;

FIG. 4 depicts a side view of the wagon of FIG. 1B in a pull position in accordance with aspects herein;

FIG. 5 depicts a side view of the wagon of FIG. 1B, illustrating rotation of a handle in accordance with aspects herein;

FIG. 6 depicts a close-up view of the portion identified in FIG. 3, illustrating a portion of a side view an exemplary embodiment of the wagon of FIG. 1B in a first push position in accordance with aspects herein;

FIG. 7 depicts a side view of the wagon of FIG. 1B in a storage position in accordance with aspects herein; and

FIG. 8 depicts a side view of the wagon of FIG. 1B with the handle in a resting position in accordance with aspects herein.

### DETAILED DESCRIPTION

Embodiments of the invention described herein include a wagon, such as a wagon for transporting a baby or small child. A wagon can receive or support a baby carrier, for example, and allow a user to move a baby or baby carrier using the wagon. Wagons often include a handle that can be used to pull the wagon. However, some wagons have handles that are used to push the wagon in front of the user, similar to a stroller. A handle that rotates may be usable for either push or pull mode, depending on user preference at a given time. To move in and out of a push position, there must be a stopping structure to position the handle into a given position for pushing. However, current structures include a cradle on the sides of the wagon into which the handle snaps, which may create a pinch point. Additionally, this stopping structure can only be used to lock the handle into one position (e.g., push position), and there is a need for embodiments of a wagon with a handle capable of rotation and locking in to more than one position, for example for different uses of the wagon, including storage.

In aspects set forth herein, the assemblies described herein include embodiments, such as a wagon, with a rotatable handle movable into multiple positions corresponding to different modes of operation. The wagon includes a wagon frame and a handle rotatable relative to the bottom frame that an rotate between a plurality of positions. In embodiments, the first position is configured for the wagon to be pushed, and the second position is configured for the wagon to be pulled. In embodiments, a third position is used for storage, and other positions can exist in between the exemplary push, pull, and storage positions. Embodiments include a linkage extending between the handle and the frame, where the linkage may be used to selectively lock the rotatable handle into one of a plurality of set locking positions, such as the push position and storage position. One end of the linkage is slidably coupled to at least a part of the handle and the other end of the linkage is rotatably coupled to the wagon frame. While the linkage may be rotatable relative to the bottom frame like the handle, some aspects include the linkage being indirectly secured to the bottom frame such that it is secured to the bottom frame at a location below the bottom frame. Embodiments further include a lock configured to lock the linkage in one of the plurality of locking positions along the length of the handle as the linkage slides along the length of the handle during rotation of the handle.

In some cases, the linkage enables a storage mode by allowing at least approximately 180 degrees of rotation. Further, the linkage may be shaped to allow for a resting position, where the handle is rotated in front of the wagon and is resting on a surface by avoiding mechanical interference with other wagon structures, such as a wheel.

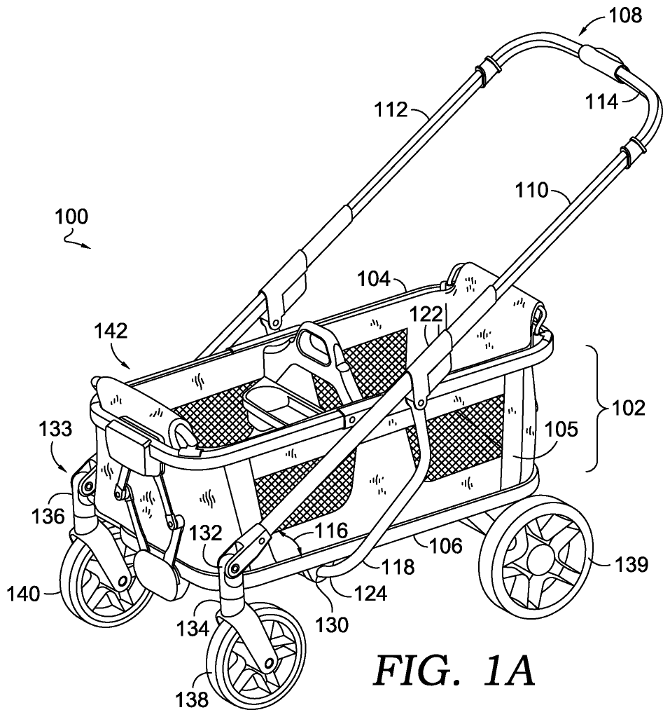

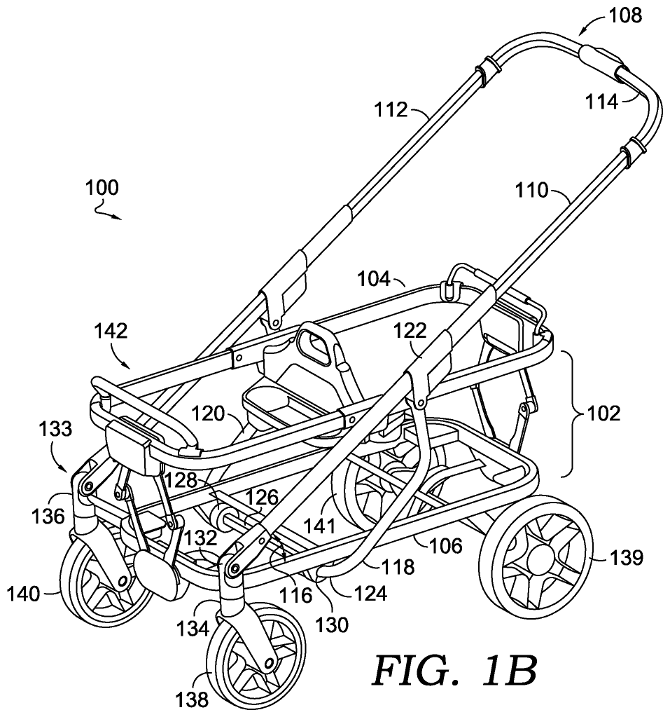

Turning to the drawings, FIGS. 1A and 1B provide perspective views of a wagon 100 in a first position. The wagon 100 includes a wagon frame 102 and a set of wheels, which may include a front pair of wheels (wheels 138 and 140) on the right and left sides and a back pair of wheels (wheel 139 and 141) on the right and left sides. In some aspects, the wagon 100 may include additional wheels or may have few wheels (e.g., a pair of back wheels and a single, centrally positioned front wheel). The wagon frame 102 defines an occupancy area, where seats for one or more occupants (such as child occupants) may be located. The wagon 100 may include wagon panels 105 along the front, back, right, and left sides of the wagon to serve as walls enclosing off the front, back, right, and left sides of the occupancy area. Example wagon panels 105 are shown in FIG. 1A but are removed from the rest of the drawings. The wagon panels 105 may be integrally formed with the wagon frame 102 or may be otherwise secured to the wagon frame 102. In various aspects, the wagon panels 105 comprise textile panels, which may include mesh subpanels, secured around various parts of the wagon frame 102. In this way, the wagon panels 105 may form softgoods of the wagon 100, which may also include one or more canopies, cushions, pockets, baskets, and the like.

Embodiment of the wagon frame 102 include a top frame 104 and a bottom frame 106. In some embodiments, only one frame in included as part of wagon 100, for example the bottom frame 106. The bottom frame 106 may be secured to or otherwise form a floor of the wagon for supporting the occupants. Further, rather than be positioned directly in the wagon 100, occupants may be received in the wagon through a secondary carrier. For example and as will be understood by those of ordinary skill in the art, the wagon 102 can receive or include a carrier or other device for securing a baby or child to the wagon 100. In one example, the top frame 104 of the wagon 100 holds a carrier that is placed onto wagon 100, while in another example, a securing device is attached to top frame 104 for attaching a carrier. Various attachment(s) or other frames can be used to secure a carrier, or a baby or child, to the wagon 100. In embodiments, the top frame 104 and the bottom frame 106 are both substantially rectangular in shape, but one or more both of the frames 104 and 106 can have other configurations, such as substantially square shaped or oval shaped instead, for example.

As shown in the embodiment in FIGS. 1A and 1B, the wagon 100 includes a handle 108 secured to the wagon frame 102 and extending up from the wagon frame 102 in the view shown in FIGS. 1A and 1B. The handle 108 of the wagon 102 comprises a first side handle portion 110 and a second side handle portion 112, which are parallel to each other. The first side handle portion 110 and the second side handle portion 112 each extend up from the bottom frame 106 on either side of the wagon 100. The handle 108, in the embodiment shown in FIG. 1, includes a top handle portion 114. A user of a wagon 100 holds the top handle portion 114 to push the wagon 100 forward, for example. The first side handle portion 110 and the second side handle portion 112 are joined at the top by the top handle portion 114, creating a U-shaped handle 108, which extends above the wagon frame 102 in at least the use position showed in FIGS. 1A and 1B, in embodiments.

The handle 108 rotatably connects to a wagon frame 102 at first connection 132 and second connection 133, in the embodiment shown in FIGS. 1A and 1B. In some cases, the first connection 132 and second connection 133 comprise hinges or screws that allow rotation of the handle 108 relative to the wagon frame 102. In one example, the first connection 132 and the second connection 133 are formed on portions of the bottom frame 106 where the bottom frame 106 is secured to one of the set of wheels, such as the first and second front wheels 138 and 140. Particularly, the first connection 132 and the second connection 133 may be positioned above the first wheel mount 134 and the second wheel mount 136, that connect the front wheels 138, 140 to the bottom fame 106. In this way, the first connection 132 may be directly or indirectly located above a first front wheel 138, while the second connection 133 may be directly or indirectly located above a second front wheel 140. This can allow the handle 108 to be connected above the first and second front wheels 138, 140, so that a user can push the wagon 100 and steer the wagon 100 more efficiently using the handle 108. In some cases, at least part of the first connection 132 and the second connection 133 (e.g., hinge components) extend above the bottom frame 106 or outward or inward from a bottom frame 106, so that a screw or other mechanism at the first connection 132 and the second connection 133 allow the handle 108 to rotate relative to the bottom frame 106.

It is also contemplated that the handle 108 may be connected directly to the bottom frame 106 at locations adjacent to but not above the rear wheels 139, 141. Further, in other embodiments, the handle 108 may be secured to other portions of the frame 102, such as the top frame 104.

FIGS. 1A and 1B show a first angle 116 created by the handle 108 and the bottom frame 106. In the example shown in FIG. 1, the first angle 116 is less than ninety degrees, because the handle 108 is tilted or rotated relative to the bottom frame 106 such that the handle 108 can be held by a user standing behind the wagon 100 shown in FIG. 1. In some aspects, the first angle 116 may be less than 60 degrees. In embodiments, when handle 108 is at the first angle 116 shown in FIGS. 1A and 1B, the handle 108 is in a “push” position. For example, the “push” position can include the handle 108 locked or fixed into a position where the first angle 116 is less than ninety degrees, and the handle 108 can be used to “push” the entire wagon 100 forward when standing behind the wagon 100.

The exemplary wagon 100 shown in FIG. 1 includes a first linkage 118 extending between the handle 108 and the wagon frame 102. The wagon 100 in FIG. 1 also includes a corresponding second linkage 120, also extending from the handle 108 to the wagon frame 102 on the opposite side of the wagon 100 as the first linkage 118. For example, the first linkage 118 extends from the first side handle portion 110 to the bottom frame 106, and the second linkage 120 extends from the second side handle portion 112 to the bottom frame 106. The first linkage 118 and the second linkage 120 may be mirror-image structures such that further discussion with respect to one of the linkage 118 or 120 may apply to the other linkage with corresponding parts on the opposite side of the wagon 100 unless otherwise indicated but such details for the other side may not be repeated for brevity.

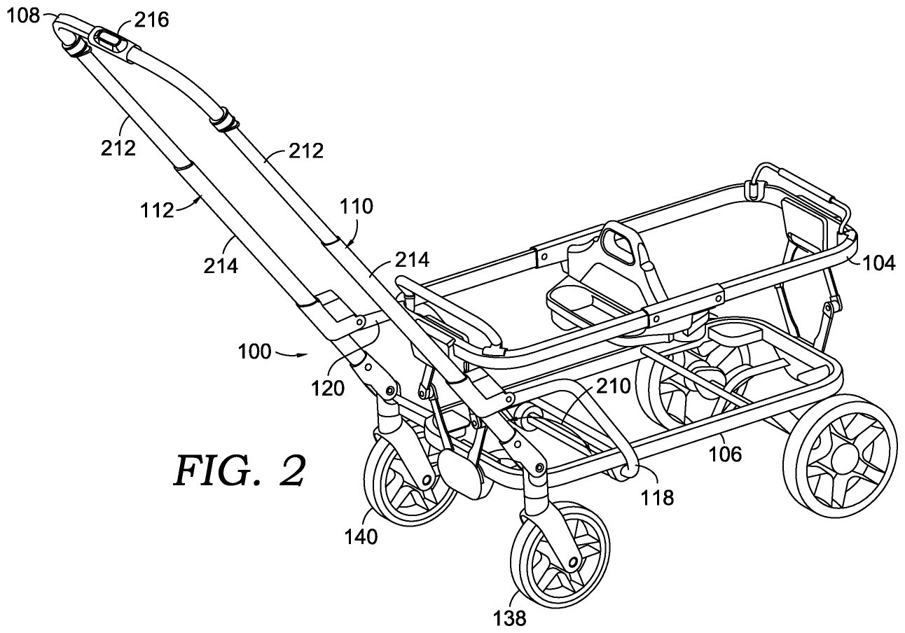

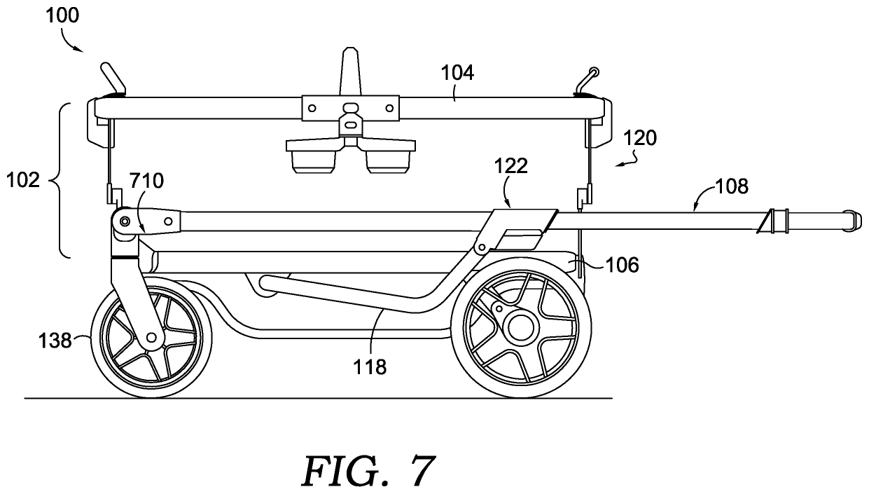

In embodiments, a first end 122 of the first linkage 118 is slidably coupled to the first side handle portion 110, such that the point where the first linkage 118 meets the first side handle portion 110 shifts up or down the length of the first side handle portion 110 as the handle 108 is rotated relative to the wagon frame 102. In the embodiment illustrated at FIGS. 1A and 1B, the first linkage 118 has a second end 124 opposite the first end 122 and that is rotatably coupled to the wagon frame 102. When the handle 108 is rotated, in embodiments, the first angle 116 shown in FIGS. 1A and 1B increases or decreases. For example, as described below, the first angle 116 can decrease to zero when the handle 108 is lowered behind the wagon 100 into a “storage” position (as shown in FIG. 7), and the first angle 116 can increase to greater than ninety degrees when the handle 108 is rotated to the other side of the wagon (as shown in FIG. 2) into a “pull” position.

Continuing with the embodiment shown in FIG. 1, the wagon 100 includes a rod 126, which may be generally parallel to the ground and to the top handle portion 114 of the handle 108. The rod 126 extends between the right and left sides of the bottom frame 106. The rod 126 may connect the first linkage 118 and the second linkage 120. In some aspects, the rod 126 extends generally orthogonal to the first and second linkages 118, 120. Because the first and second linkages 118, 120 are each connected to one side of the handle 108, synchronized rotation of the first and second linkages 118, 120 is desired for the handle 108 to be able to rotate into different positions. The first and second linkages 118, 120 are indirectly connected to each other via the handle 108 (which is coupled at their first ends 122) but the rod 126 creates an additional connection point at the second ends 124 of the first and second linkages 118, 120, which creates a smoother synchronized rotation motion. Additionally, the rod 126 laterally extending between the first and second linkages 118, 120 provides stabilization by preventing lateral movement of the first and second linkages 118, 120 and, consequently, of the handle 108.

As shown in FIGS. 1A and 1B, the rod 126 may extend through connection structures 128, 130 of the bottom frame 106, which may serve to connect the first linkage 118 and the second linkage 120 to the bottom frame 106. In this way, the first linkage 118 and the second linkage 120 may each be indirectly secured to the bottom frame 106 via connection structures 128, 130. In some embodiments, the connection structures 128, 130 extend below the bottom frame 106 and receive the first linkage 118 and the second linkage 120 at positions below the bottom frame 106. In this way, the second ends 124 of the first and second linkages 118, 120 where rotation occurs is positioned below the bottom frame 106. This allows the use of the rod 126 to stabilized and better synchronize the linkages 118, 120 without interfering with the bottom frame 106, where such interferences may diminish the structural integrity of the bottom frame 106.

In some embodiments, the connection structures 128, 130 that connect the first and second linkages 118, 120 to the bottom frame 106 are separate components from the bottom frame 106 but extend below the bottom frame 106 and rotatably connect to the first linkage 118 and the second linkage 120. In other embodiments, the connection structures 128, 130 extend inwardly or outwardly from the bottom frame 106 and receive or connect to the first linkage 118 and the second linkage 120. Further, the connection structures 128,130 may be integral and have a unitary structure with the bottom frame 106. The rod 126 may extend horizontally in between the structures 128, 130, in embodiments. The structures 128, 130 allow rotation of the first linkage 118 and the second linkage 120 relative to the wagon frame 102, in accordance with embodiments described herein.

In embodiments, only the bottom frame 106 of the wagon 100 interacts or connects with the handle 108, the first linkage 118, and the second linkage 120, with the handle 108 remaining free of any other connections to the wagon 100, to enable rotation of substantially 180 degrees (or more) by the handle 108 relative to the wagon frame 102.

In embodiments, a body 142 of the wagon 100 is collapsible, which can make the body 142 of the wagon 100 more compact for storage or transport, for example. The body 142 of the wagon 100 may include the top frame 104 and bottom frame 106 and any side panels (e.g., wagon panels 105) and can be collapsed by bringing the top frame 104 and the bottom frame 106 closer together. In other words, the distance between the top frame 104 and the bottom frame 106 may be reduced, and in some instances, the top frame 104 may contact the bottom frame 106 when the body 142 of the wagon is fully collapsed, although it is also contemplated that there may be some spacing between the top frame 104 and the bottom frame 106. When collapsed, the wagon panels 105 may also collapsed. For example, the wagon panels 105 may be a textile capable of being folded or scrunched when the top frame 104 and bottom frame 106 are moved closer together. In some cases, in addition to collapsing the body 142, the wheels (including first front wheel 138 and second front wheel 140) may be rotated and/or folded inwards for a more compact configuration. Other parts of the wagon 100 can be collapsed or compacted for storage or transport, in accordance with embodiments described herein.

Turning now to FIG. 2, a second perspective view of the wagon 100 is illustrated. In FIG. 2, the handle 108 is shown rotated into a second position, for example a “pull” position. In this position, the handle 108 has been rotated relative to the bottom frame 106, such that a second angle 210 shown in FIG. 2, where the second angle 210 is greater than ninety degrees and the handle 108 extends in front of the first front wheel 138 and the second front wheel 140. In the “pull” position shown in the example in FIG. 2, the handle 108 can be non-fixed with respect to rotation relative to the bottom frame 106, such that the handle 108 can continue to rotate relative to the bottom frame 106 during use. Remaining unfixed allows for the small changes in the handle 108 position during a pulling motion, which can allow for a more comfortable grip when the user is pulling the handle 108 behind themselves.

As one example, a user can stand in front of the wagon 100, in front of the first front wheel 138 and the second wheel 140, and the user can hold the handle 108 at various heights in front of the wagon 100 as the user “pulls” the wagon 100. In this example, where the handle 108 is non-fixed with respect to rotation relative to the bottom frame 106, the second angle 210 can change during use as the handle 108 is lowered or raised in front of the wagon 100. In embodiments, the second angle 210 generally remains above ninety degrees but can vary between ninety degrees and 180 degrees. When the handle 108 is pulled in front of the wagon 100 until the second angle 210 is nearly 180 degrees, the handle 108 would be nearly parallel to the ground and would extend nearly straight from the bottom frame 106. In embodiments, the handle 108 is loose or free to rotate relative to the bottom frame 106 when the handle 108 is in front of the wagon 100 in a “pull” position. In other embodiments, the handle 108 is fixed into a “pull” position, such that the second angle 210 does not change during use of the wagon 100 in the “pull” position.

The first side handle portion 110 and the second side handle portion 112, as shown in the exemplary embodiment in FIG. 2, may each include a first extension portion 212 and a second extension portion 214. The first extension portion 212 and the second extension portion 214 enable a user to adjust the length of the handle 108, for example to accommodate users of various heights or users with preferences to hold the handle 108 at various heights or distances with respect to the wagon 100. For example, a user can use a button 216, as shown in FIG. 2, to extend the handle 108 using the first extension portion 212 and/or the second extension portion 214 in this telescoping manner. The user may press the button 216 to unlock one or more extension portions, such as the first extension portion 212 and/or the second extension portion 214, thereby lengthening the handle 108. A user may press the button 216 to retract or collapse the first extension portion 212 and/or the second extension portion 214, to shorten the handle 108, in some cases. In embodiments, only one extension portion (e.g., the first extension portion 212 or the second extension portion 214) is included as part of the handle 108. In some cases, the handle 108 does include any extension portions or may include fewer or more extension portions.

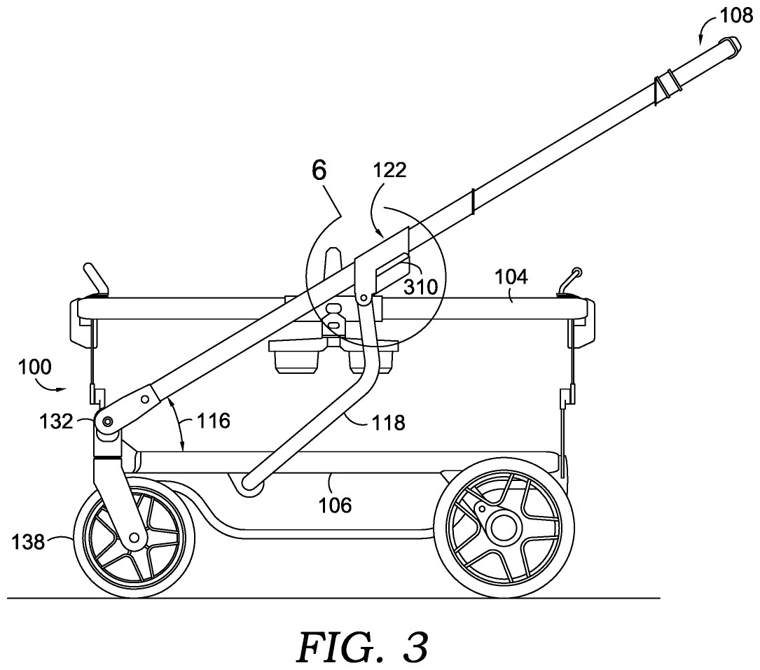

Turning now to FIGS. 3-7, side views of the wagon 100 in different configurations for the push, pull and storage modes (as well as additional details of those side views) are provided. In FIG. 3, a first side view of an exemplary embodiment of a wagon 100 is shown in a “push” configuration similar to FIGS. 1A and 1B. The handle 108 is shown rotated, via the first connection 132 above the first front wheel 138, such that the handle 108 extends upward and behind the wagon 100. In this embodiment, the first angle 116 between the handle 108 and the bottom frame 106 is less than ninety degrees. In some aspects, the first angle 116 is less than sixty degrees. The example shown in FIG. 3 represents the wagon 100 in a “push” position, where the handle can be used by a user standing behind the wagon 100 (meaning to the right of the wagon 100 in FIG. 3) in order to push the wagon 100 forward and to steer the wagon 100. In this example, the handle 108 can be fixed or rigid in the “push” position to provide control to the user. It is contemplated, however, that in other embodiments, the handle 108 can be non-fixed in the “push” position so that the handle can be rotated while in use by a user standing behind the wagon 100.

Continuing with the embodiment shown in FIG. 3, the first end 122 of the first linkage 118 is slidably coupled to the handle 108. The first end 122 of the first linkage 118 can slide up or down the handle 108 as the handle 108 rotates relative to the bottom frame 106. As discussed below, the first linkage 118 can be locked or fixed into a point along the length of the handle 108 to stabilize the handle 108 at a degree of rotation (i.e., to maintain the first angle 116). In embodiments, the first end 122 of the first linkage 118 includes a locking mechanism further described herein for securing the first end 122 of the first linkage 118 to that point along the handle 108 and, therefore, secure the handle 108 at a particular degree of rotation relative to the bottom frame 106.

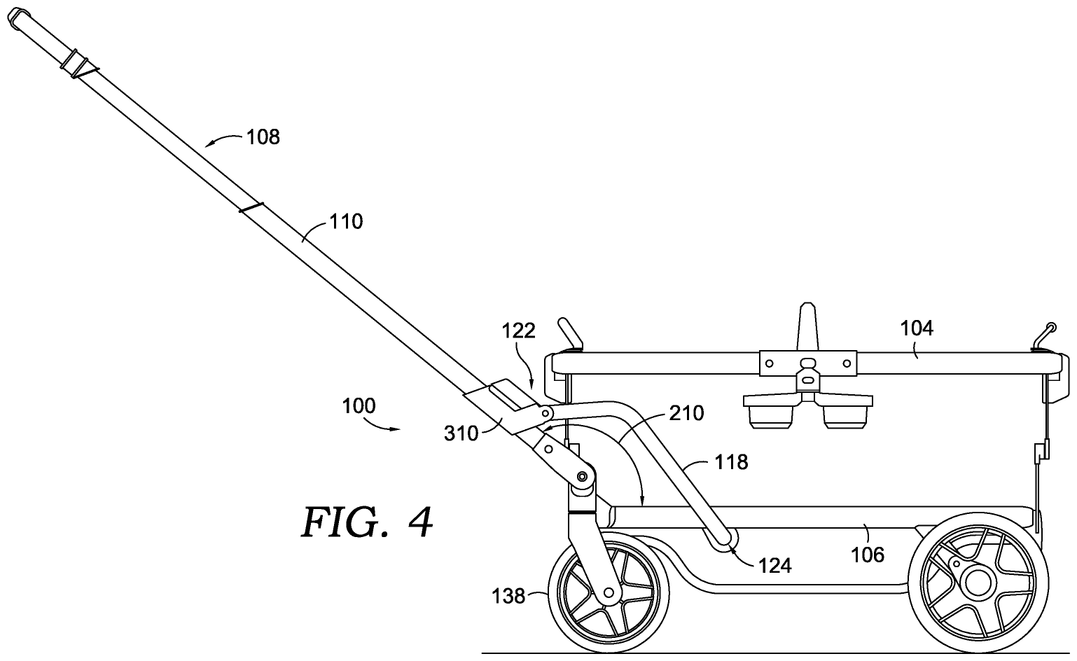

Moving on to FIG. 4, a second side view is shown with the wagon 100 in a “pull” configuration, similar to FIG. 2. In the embodiment shown in FIG. 4, the handle 108 of the wagon 100 has been rotated so that it extends beyond the front of the wagon 100 (to the left of the wagon 100 as illustrated in FIG. 4). The handle 108 in FIG. 4 represents an embodiment of a wagon 100 in a “pull” position, where the second angle 210 is greater than ninety degrees. In this example, the first linkage 118 not extends above the first front wheel 138. Although not shown in this view of FIG. 4, in this embodiment, the second linkage 120 would be located above the second front wheel 140, on the other side of the wagon 100.

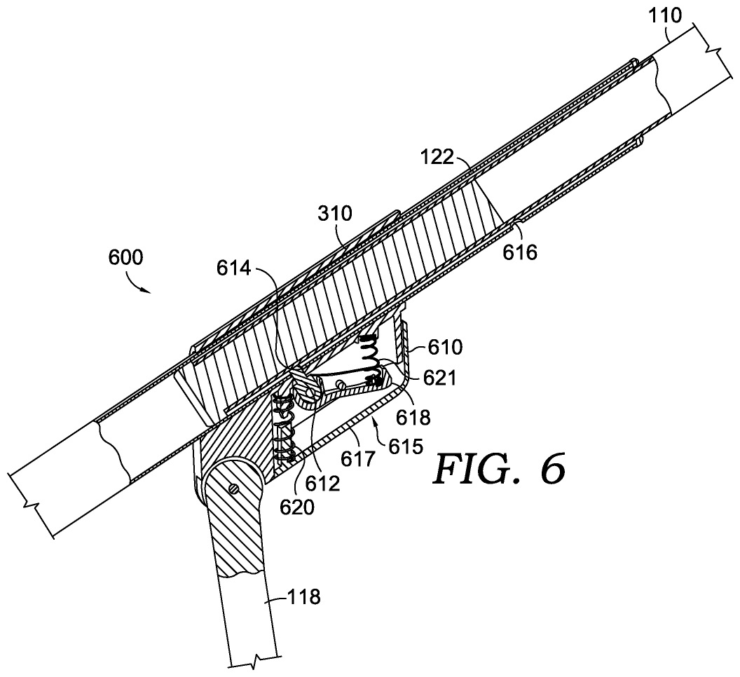

As the handle 108 moves between the configurations of FIGS. 3 and 4, the first and second linkages 118, 120 move along the length of the respective side handle portions 110, 112. In particular, the first end 122 of each of the first and second linkages 118, 120 may slide along the side handle portions 110, 112. The first end 122 includes a securing structure 310 that secures the first end 122 to the handle 108 while allowing for a sliding movement. In this example, the securing structure 310 at the first end 122 of each of the first and second linkages 118, 120 forms a hollow portion that receives the respective side handle portion 110, 112 so that the securing structure 310 at least partially wraps around the respective side handle portion 110, 112. In some aspects, the securing structure 310 fully wraps around the circumference of the respective side handle portion 110, 112. The securing structure 310 may further includes a handle lock further described herein with respect to FIG. 6. The securing structure 310 may be an integral part of the first end 122 of the first linkage 118 such that the securing structure 310 may have a unitary structure with the rest of the first linkage 118, or the securing structure 310 may be formed separately from the rest of the first linkage 118 and later secured to form the first end 122. Further, in other examples, the handle 108 may form a hollow receiving area so that it completely or partially surrounds the first linkage 118 while the first linkage 118 may be configured to slide within a the receiving area of the handle 108.

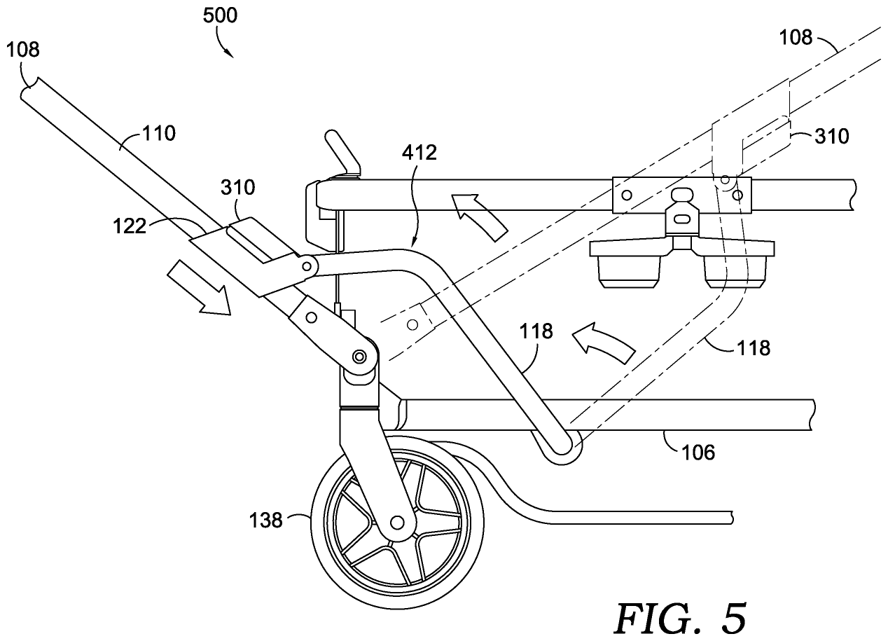

Turning now to FIG. 5, a close-up view of a portion 500 of a wagon 100 is shown, in accordance with embodiments described herein. In this portion 500, handle 108 is shown slidably connected to the first linkage 118 via the first end 122 of the first linkage 118 via the securing structure 310. The solid lines of the handle 108 and the first linkage 118 depict these parts as they may be in a “pull” configuration as seen in FIG. 4, while phantom lines depict the handle 108 and the first linkage 118 as they may be in a “push” configuration as seen in FIG. 3.

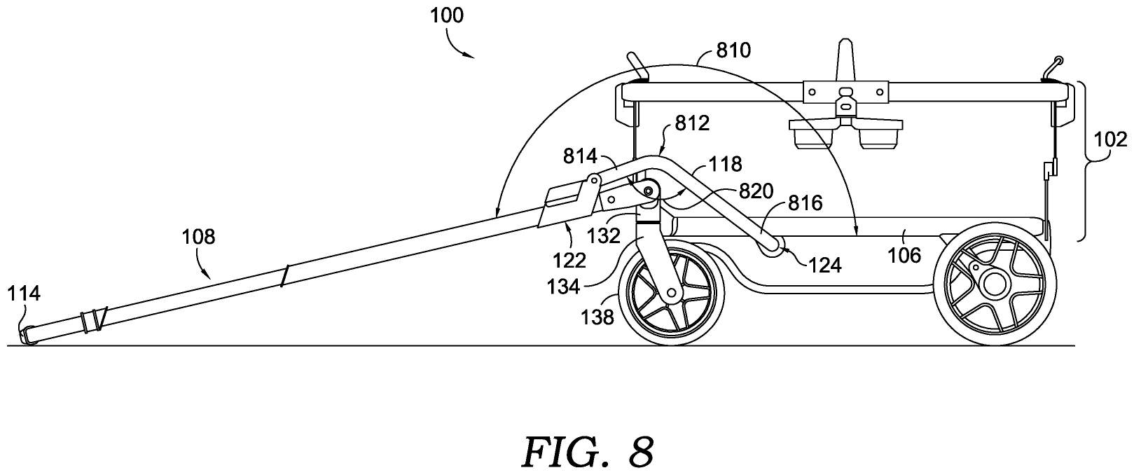

The arrows in FIG. 5 indicate how the handle 108 and the first linkage 118 may be rotated from a rearward extending position from the “push” configuration as shown in the phantom lines to the more forwardly extending position for the “pull” configuration. Further, another arrow in FIG. 5 depicts how the first end 122 of the first linkage 118 slides down the handle 108 (the first side handle portion 110) to a lower position on the handle 108 as the handle 108 is rotated to extend outwardly in front of the wagon 100 for the “pull” configuration. In this way, the first end 122 of the first linkage 118 is relatively lower on handle 108 when the handle 108 is in the “pull” configuration compared to when the handle 108 is in the “push” configuration. In embodiments, the handle 108 can be rotated relative to a frame, such as the bottom frame 106, approximately 180 degrees, extending from a position with the handle 108 extended nearly straight out in front of the wagon 100 and parallel to the ground (as seen in FIG. 8), through multiple positions or degrees of rotations, including until the handle 108 has been rotated approximately 180 degrees and the handle 108 extends behind the wagon 100 nearly straight and approximately parallel to the ground in a “storage” position, as shown in FIG. 7, described below.

FIG. 6 illustrates a cross-sectional view 600 of a portion of the embodiment shown at FIG. 3. In the cross-sectional view 600 in FIG. 6, the first end 122 of the first linkage 118 is shown surrounding the first side handle portion 110 of the handle 108. Particularly, the securing structure 310 at the first end 122 of the first linkage 118 may surround the first side handle portion 110 and is configured to slide along and around the first side handle portion 110 as the handle 108 is rotated relative to a wagon frame 102. In some embodiments, the first end 122 completely surrounds the first side handle portion 110, while in other embodiments, the first end 122 only partially surrounds the part of the handle 108 where the first end 122 is slidably connected to the handle 108. In other aspects, the securing structure 310 at the first end 122 of the first linkage 118 may not surround the handle 108 at all but rather, may be inserted into a slot or other shape on the first side handle portion 110 and configured to slide within the slot or other receiving structure in the first side handle portion 110. Further yet, other embodiments may include the handle 108 completely or partially surrounding the first linkage 118 while the first linkage 118 slides within a cavity formed by the handle 108.

The embodiment in FIG. 6 also illustrates an example of a handle lock 610 for securing or fixing the handle 108 into a particular position or rotation. Various locks or securing methods can be used to fix the first end 122 of the linkage 118 to the handle 108 (i.e., the first side handle portion 110) at a plurality of points along the handle 108, as the handle 108 is rotated among various positions, including an exemplary “push” position as shown in FIG. 1 and an exemplary “pull” position as shown in FIG. 2. Additionally, the handle 108 can be lowered further from the “push” position shown in FIG. 1 until the handle 108 is in a “storage” position, for example as shown in FIG. 7. The handle 108, as it is rotated relative to the wagon frame 102, can be locked into various positions. As the handle 108 is rotated, the first end 122 of the first linkage 118 slides along the first side handle portion 110 of the handle 108 (while the first end 122 of the second linkage 120 slides along the second side handle portion 112).

FIG. 6 further shows an embodiment of a handle lock 610 within the securing structure 310 at the first end 122 of the first linkage 118. The handle lock 610 may secure the first end 122 of the first linkage 118 to one of multiple positions along the first side handle portion 110. By locking the first end 122 of the first linkage 118 in a particular position on the first side handle portion 110, the first linkage 118 can no longer move along the length of the first side handle portion 110 and thus the handle 108 can no longer freely rotate. In this way, the handle 108 may be maintained in a selected position (e.g., a “push” position as shown in FIG. 6 or a “storage” position).

In the embodiment shown in FIG. 6, the handle lock 610 incudes a pin 612 that can be selectively moved in and out of openings on the handle 108. FIG. 6 shows the pin 612 being engaged within a first opening 614 on the first side handle portion 110 to secure the first end 122 of the first linkage 118 at a fixed point along the first side handle portion 110. The first opening 614 corresponds to a certain position of the handle 108, such as the exemplary “push” position illustrated in FIG. 1. As shown in FIG. 6, other openings may be included along the handle 108, which can interact with pin 612 to secure the linkage 118 at a different point along the handle 108, for example corresponding to another “push” position (e.g., configured to push at a different angle) and/or to a “pull” and/or “storage” position of the handle 108. In some examples, these other openings may allow for rotation of the handle 108 at least approximately 180 degrees. As one example of an additional opening along the handle 108, a second opening 616 is shown higher up on the handle 108. The first end 122 of the first linkage 118 can slide along the handle 108 until the pin 612 interacts with the second opening 616, at which point the handle 108 would be rotated so that it is lowered relative to the wagon frame 102, for example into a “storage” position. As mentioned, it should be understood that additional openings on the first side handle portion 110 may be present. Additionally, the pin 612 may interact with a groove or indent in the handle 108 rather than a complete opening.

As shown in FIG. 6, the handle lock 610 may include an actuator 615 to facilitate fixing the pin 612 into an opening, such as the first opening 614. The pin 612 is positioned on a first end of a pivoting arm 618, which includes a second end opposite the first end. The actuator 615 further includes an outer wall 617 that may be pressed in towards the first side handle portion 110, which may then push the second end of the pivoting arm 618 towards the first side handle portion 110. As the second end of the pivoting arm 618 is rotated towards the first side handle portion 110, the first end of the pivoting arm 618 and the attached pin 612 rotates away from the first side handle portion 110 until the pin 612 is removed from the first opening 614 of the first side handle portion 110. Once the pin 612 is removed, the first end 122 of the first linkage 118 may slide along the first side handle portion 110. When the actuator 615 is released, a biasing element (e.g., a first spring 620) may cause the outer wall 617 of the actuator 615 to move away from the first side handle portion 110 so that the outer wall 617 no longer presses against the second end of the pivoting arm 618. A second biasing element (e.g., a second spring 621) attached to the second end of the pivoting arm 618 may apply a force to the pivoting arm 618 so that the first end with the pin 612 may be rotated back towards the first side handle portion 110 and into another opening (e.g., second opening 616) when the pin 612 is aligned with another opening.

In some cases, other mechanisms can be used to secure the first end 122 to the handle 108, such as other indentations or openings, for example in a ring shape other configuration. In some cases, one or more rings or protrusions are used to secure the first end 122 to the handle 108. Embodiments described herein are not limited to a pin 612 as shown in the example in FIG. 6. Additionally, in some embodiments, the handle 108 can include one or more pins while the first end 122 of the first linkage 118 includes one or more openings for receiving the one or more pins.

In one example, three opening exist along handle 108, one for a first “push” position with the handle 108 extending out behind the wagon 100 (as shown in FIG. 1), another one for a second “push” position with the handle 108 extending out behind the wagon 100 at a different angle (which may be advantageous to accommodate users of different heights), and a third opening for a “storage” position where the handle extends nearly straight from the bottom frame 106 and behind the wagon and is substantially parallel to the ground as further described with respect to FIG. 7. In some embodiments, two openings exists, with one opening for fixing the handle in a single “push” position as shown in FIG. 1, and another for fixing the handle in a “storage” position, but no opening is used for the pin 612 when the handle 108 is in the “pull” position so that the handle remains flexible and rotatable during use in the “pull” position.

Turning to FIG. 7, a side view of wagon 100 is shown, in this case in a “storage” configuration. In this exemplary embodiment, the handle 108 has been rotated and lowered behind the wagon 100 (on the far-right side of the image in FIG. 7), such that the handle 108 (which may include the hollow portion that contains part of the first linkage 118) is nearly parallel to the ground. In this example, a third angle 710 between the handle 108 and the wagon frame 102 is nearly zero. In this positon, the handle 108 generally surrounds the right, left, and back side of the wagon frame 102. In this storage position, the handle 108 can be fixed or locked for storage and the handle 108 can also be non-extended or retracted to be shorter for storage. With the handle 108 in this storage position so that it is wrapped around the wagon frame 102, the wagon 100 may be tilted and positioned to rest on the front side as another option for storing the wagon 100. It should also be understood that, although not shown in FIG. 7, the body 142 of the wagon 100 may be collapsed so that top frame 104 is positioned closer to the bottom frame 106 when in the storage configuration.

FIG. 8 depicts the wagon 100 in one example resting configuration. When a user is pulling the wagon 100, the user may need or desire to momentarily stop before later resuming the pulling action. Rather than rotate the handle 108 to rear side of the wagon, the user may simply rest the handle 108 (particularly, the top handle portion 114) on a ground surface in front of the wagon frame 102, which is depicted in FIG. 8. As can be seen, the handle 108 is rotated fully in front of the wagon frame 102 and is rotated further than what is seen in the “pull” configuration show in FIGS. 2 and 4 as the top handle portion 114 rests on the ground surface. A fourth angle 810 between the bottom frame 106 and the first linkage 118 may be greater than the second angle 210 shown in one example pulling position in FIGS. 2 and 4. The fourth angle 810 may be greater than 180 degrees. When comparing the resting position of the handle 108 in FIG. 8 to the storage position of the handle 108 in FIG. 5, it can be seen that some examples of the handle 108 are configured to rotate relative to the bottom frame 106 greater than 180 degrees.

As shown in FIG. 8, the first linkage 118 has a curved body in that it includes a curvature 812. This curvature 812 enables the first linkage 118 to not interfere with the first front wheel structure, which includes the front wheel 138, the wheel mount 134, and the first connection 132 that connects the first front wheel 138 and to wagon frame 102). Particularly, the curvature 812 in the first linkage 118 prevent the first linkage 118 from grazing or otherwise interfering with the front wheel structure when the handle 108 is in a resting position. It will be appreciated that the curvature 812 of the first linkage 118 may similarly prevent interference between the first linkage 118 and the front wheel structure when the handle 108 is a lower “pull” position, such as when it is pulled by a user of a lower height. The curvature 812 curves away from the front wheel structure when the handle 108 is in the resting positon shown in FIG. 8. Further, as can be seen in the other figures, the curvature 812 may curve away from the handle 108 in all handle positions. On the other side of the wagon 100, a similar curvature of the second linkage 120 would also allow or provide space above the second front wheel 140 and the second connection 133.

The curvature 812 of the first linkage 118 separates a first portion 814 of the first linkage 118 adjacent the first end 122 and a second portion 816 adjacent the second end 124. The first portion 814 is angled relative to the second portion 816 to form the curvature 812. The angle 820 between the first and second portions 814, 816 of the first linkage 118 may be at least 90 degrees and, in various examples, is greater than 90 degrees. In some examples, the angle 820 is between approximately between 100 degrees and 150 degrees.

Additionally, the curvature 812 may be offset from the midline of the first linkage 118. In other words, the distance between the curvature 812 and the first end 122 of the first linkage 118 may be different from the distance between the curvature 812 and the second end 124 of the first linkage 118. As seen in FIG. 8, in some embodiments, the curvature 812 may be offset closer to the first end 122 such that the distance between the curvature 812 and the first end 122 may be less than the distance between the curvature 812 and the second end 124.

Many different arrangements of the various components depicted, as well as components not shown, are possible without departing from the scope of the claims below. Embodiments of this technology have been described with the intent to be illustrative rather than be restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

The subject matter of embodiments of the invention is described with specificity herein to meet statutory requirements. However, the description itself is not intended to limit the scope of this patent. Rather, the inventors have contemplated that the claimed subject matter might be embodied in other ways, to include different assemblies similar to the ones described in this document, in conjunction with other present or future technologies. Moreover, although certain actions or steps may be described herein to connote different aspects, the terms should not be interpreted as implying any particular order among or between various actions or steps disclosed herein unless explicitly described. Words such as “a” and “an,” unless otherwise indicated to the contrary, may also include the plural as well as the singular. Thus, for example, the constraint of “a feature” is satisfied where one or more features are present. Furthermore, the term “or” includes the conjunctive, the disjunctive, and both (a or b thus includes either a or b, as well as a and b). Additionally, the terms “substantially, “approximately” and “about” means within ±5% of an indicated value.

What is claimed is:

1. A wagon with multiple modes of operation comprised of:
a wagon frame comprising a top frame and a bottom frame;
a handle rotatable, relative to the bottom frame, between a plurality of positions including a first position and a second position, wherein the first position is configured for the wagon to be pushed and the second position is configured for the wagon to be pulled;
a first linkage having a first end slidably coupled to a first side of the handle and a second linkage having a first end slidably coupled to a second side of the handle, the first linkage and the second linkage each having a second end rotatably coupled to the wagon frame at a positioned below the bottom frame; and
a rod positioned below the bottom frame and extending between the first linkage and the second linkage.

2. The wagon of claim 1, further comprising a handle lock that selectively locks the handle in the first position.

3. The wagon of claim 1, wherein the handle remains unlocked in the second position.

4. The wagon of claim 2, wherein the handle lock comprises:
a first pin on one of the first linkage or the handle, wherein the first pin engaging with the other of the first linkage or the handle causes the handle to lock in the first position.

5. The wagon of claim 1, wherein the handle is further rotatable, relative to the bottom frame, to a third position, wherein the third position is configured for the wagon to be stored.

6. The wagon of claim 5, further comprising a handle lock that selectively locks the handle in the third position.

7. The wagon of claim 1, wherein the top frame is collapsible towards the bottom frame.

8. A wagon with a positionable handle, the wagon comprising:
a wagon frame including a bottom frame portion and a set of wheels secured to the bottom frame portion;
a handle that is positionable relative to the bottom frame portion between a plurality of handle positions, the handle being secured to the bottom frame portion at a position above a first wheel of the set of wheels; and
a linkage, with a first end of the linkage connected to the handle and a second end of the linkage secured to the bottom frame portion, wherein the linkage is movable along a length of the handle, the linkage having a curved body between the first end and the second end, the curved body curving away from the first wheel when the handle is at least in one handle position within the plurality of handle positions.

9. The wagon of claim 8, further comprising a lock configured to lock the linkage to the handle in one of a plurality of locking positions along the length of the handle to secure the handle in one of the plurality of handle positions.

10. The wagon of claim 9, wherein the plurality of handle positions includes at least one handle position corresponding to a push use configuration of the handle, the plurality of locking positions along the length of the handle including a push locking position to secure the handle in the at least one handle position corresponding to the push use configuration.

11. The wagon of claim 10, wherein the plurality of handle positions of includes at least one storage position wherein the handle is substantially parallel to the bottom frame portion, the plurality of locking positions along the length of the handle including a storage locking position to secure the handle in the at least one storage position.

12. The wagon of claim 10, wherein the linkage is indirectly secured to the bottom frame portion via a connection structure that extends below the bottom frame.

13. The wagon of claim 9, wherein each locking position within the plurality of locking positions includes an opening or groove configured to receive a locking structure on the handle.

14. The wagon of claim 9, wherein the lock includes a pin and an actuator configured to move the pin to selectively engage with the handle.

15. The wagon of claim 8, wherein the bottom frame portion comprises a wheel mount securing the first wheel to the bottom frame portion, and wherein the handle is rotatably connected to the wheel mount.

16. A wagon assembly comprising:
a wagon frame including a bottom frame;
a handle rotatable relative to the bottom frame;
a linkage that slides relative to the handle at a first end of the linkage, and rotates relative to the bottom frame, wherein the linkage enables a storage mode by allowing at least approximately 180 degrees of rotation.

17. The wagon assembly of claim 16, wherein the first end of the linkage includes a hollow portion that surrounds a first portion of the handle, the handle configured to slide within the hollow portion.

18. The wagon assembly of claim 17, wherein the hollow portion is substantially parallel to the bottom frame when the wagon assembly is in the storage mode.

19. The wagon assembly of claim 16, further comprising:
a locking mechanism associated with different positions along the handle, each the locking mechanism configured to maintain the handle in a particular position relative to the wagon frame based on the position of the locking mechanism along the handle.

20. The wagon assembly of claim 16, further comprising:
a first curved portion of the linkage, wherein the first curved portion is located above a wheel of the wagon assembly when the wagon assembly is rotated in a position that is at least 180 degrees of rotation from a storage mode position.
